(19) United States
(12) Patent Application Publication
(10) Pub. No.: US 2011/0067857 A1
(43) Pub. Date: Mar. 24, 2011

(54) DETERMINING PROPERTIES OF A SUBTERRANEAN STRUCTURE DURING HYDRAULIC FRACTURING

(75) Inventors: William UNDERHILL, Richmond, TX (US); R.K. Michael THAMBYNAYAGAM, Sugar Land, TX (US); Jeff SPATH, Missouri City, TX (US); Raj BANERJEE, Abingdon (GB); Amina BOUGHRARA, Abingdon (GB)

(73) Assignee: SCHLUMBERGER TECHNOLOGY CORPORATION, Houston, TX (US)

(21) Appl. No.: 12/565,094

(22) Filed: Sep. 23, 2009

(51) Int. Cl. E21B 47/00; E21B 43/26; G01V 9/00; G06F 19/00

(52) U.S. Cl. 166/250.01; 702/9

(57) ABSTRACT

A technique includes receiving, during a hydraulic fracturing operation in a subterranean structure, pressure data and fluid injection rate data. One or more properties of the subterranean structure are determined in real-time using the received pressure data and fluid injection rate data.

### BACKGROUND

Reservoir development is performed to produce fluids such as hydrocarbons, fresh water, and so forth, from the reservoir. Reservoir development includes drilling one or more wellbores into a subterranean formation to intersect the reservoir, and installing completion equipment in the wellbores to enable the extraction of fluids from the reservoir. Surface equipment is also provided to route or store the extracted fluids.

To enhance production of fluids from a subterranean reservoir, hydraulic fracturing can be employed. Hydraulic fracturing involves injecting a fluid at relatively high pressure through a wellbore into the reservoir. The injection pressure is chosen to be high enough to cause fracturing of the formation. The injection phase is followed by a shut-in phase (where the injection pressure is removed). The injection of fracturing fluids causes micro-seismic events to occur, which are also referred to as micro-earthquakes. Such micro-seismic events can be detected using seismic detectors.

Conventional techniques of studying reservoirs have not effectively employed available data associated with hydraulic fracturing of the reservoir to understand properties of the reservoir or characteristics of the hydraulic fracturing procedure.

### SUMMARY

In general, according to an embodiment, a technique or mechanism is provided to determine, in real-time, properties of a reservoir during a hydraulic fracturing process.

Other or alternative features will become apparent from the following description, from the drawings, and from the claims.

### BRIEF DESCRIPTION OF THE DRAWINGS

FIG. 1 is an exemplary plot illustrating a seismic cloud produced during a hydraulic fracturing process.

FIGS. 2A-2B are plots illustrating pressure build-up and pressure fall-off phases of a hydraulic fracturing process.

FIG. 3 is a schematic diagram of an exemplary arrangement that includes a subterranean formation and a reservoir in the subterranean formation, various sensors, and a computer that incorporates an embodiment.

FIG. 4 is a flow diagram of a process for performing analysis according to an embodiment.

### DETAILED DESCRIPTION

In the following description, numerous details are set forth to provide an understanding of the present invention. However, it will be understood by those skilled in the art that the present invention may be practiced without these details and that numerous variations or modifications from the described embodiments are possible.

A technique or mechanism according to some embodiments is provided to perform real-time determination of one or more properties of a subterranean structure, such as a reservoir in a subterranean formation, during a hydraulic fracturing process. Performing real-time determination of a property of a subterranean structure during a hydraulic fracturing process refers to making such determination while the hydraulic fracturing process is proceeding such that the determined property can be used to control the hydraulic fracturing process (such as to stop the hydraulic fracturing process or to change some characteristic of the hydraulic fracturing process, such as an injection rate, applied pressure, type of injected fluid, and so forth).

The ability to control the hydraulic fracturing process in real-time based on determination of properties of the subterranean structure allows for more efficient performance of the hydraulic fracturing process. For example, if the hydraulic fracturing has caused a reservoir to achieve target characteristics, then the hydraulic fracturing can be stopped, which would avoid unnecessary further hydraulic fracturing.

Hydraulic fracturing refers to application of a fluid into a wellbore at a relatively high pressure to cause the applied fluid to be communicated through perforations in the wellbore into the surrounding subterranean structure, where the applied fluid at high pressure is intended to cause fracturing of the subterranean structure. Fracturing of the subterranean structure refers to causing breaks to form in the subterranean structure, where fluid flow paths are provided as a result of the breaks to enhance flow of production fluids such as hydrocarbons, fresh water, or other fluids. Usually, the hydraulic fracturing is associated with an injection phase (where fracturing fluid is applied at high pressure, followed by a shut-in phase, where the injection of fluid is stopped and pressure is allowed to drop off). The injection phase is also referred to as a “build-up phase,” and the shut-in phase is also referred to as a “fall-off phase.”

Hydraulic fracturing causes micro-seismic events (also referred to as micro-earthquakes) to occur in the subterranean structure. It can be assumed that pore pressure diffusion is the primary mechanism that triggers micro-seismic events during hydraulic fracturing. Pore pressure refers to pressure of fluids within the pores of a subterranean structure.

Micro-seismic events are triggered only when the pore pressure field p(r,t) exceeds a threshold pressure field P_{T}(r). Such micro-seismic events are usually exhibited in a space-time (r-t) plot, where r is the distance to the seismic event from a wellbore (the point of injection of the fracturing fluid), and t represents time.

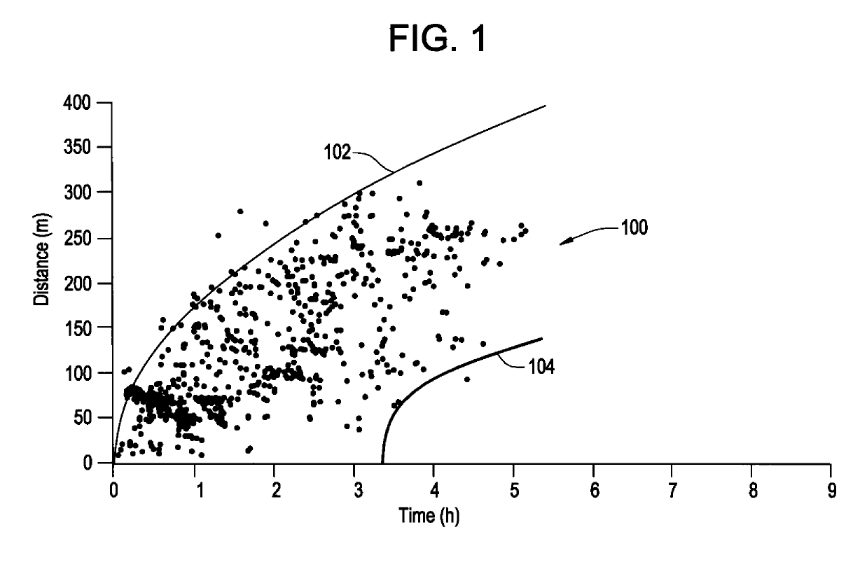

An exemplary r-t plot is shown in FIG. 1. During the injection phase, the pore pressure field will continue to exceed the threshold pressure field, triggering a swarm of micro-seismic events resulting in the formation of a seismic cloud 100 in the r-t plot. The locus of r at the left periphery of the seismic cloud 100 is known as the triggering front 102. The triggering front 102 depicts spatial demarcation of relaxed and unrelaxed pore pressure regions of the subterranean structure during the injection phase. Conversely, during the shut-in phase, the period of seismic quiescence, as the pore pressure field begins to recede towards the threshold pressure field, a locus of r, known as the back front 104, will appear at the right periphery of the seismic cloud 100. The back front 104 depicts the demarcation of relaxed and unrelaxed pore pressure regions of the formation during the shut-in phase.

The real-time determination of one or more properties of a subterranean structure according to some embodiments during the hydraulic fracturing process is based on various received measurement data, including data relating to micro-seismic events detected by micro-seismic detectors (e.g., geophones), pressure data, and fluid injection rate data. Pressure data can be collected by pressure sensors at the earth surface and/or downhole in a wellbore, while injection rate data can be collected by fluid rate sensors at the earth surface and/or downhole in the wellbore.

As examples, deduced properties regarding a subterranean structure (e.g., reservoir parameters) include storativity (ω), shape factor (α) and transmissivity (λ). Storativity is the parameter that relates fluid capacitance of the secondary (fracture) porosity to that of the combined system. Shape factor is a geometric parameter describing the distribution of a fracture network including anisotropic behavior in a heterogeneous region, and the shape factor is estimated with input from micro-seismic focal mechanism inversions. Transmissivity is the parameter governing flow between the fractures and primary matrix.

A technique according to an embodiment entails performing, in real-time, a constrained history matching of pressure build-up and fall-off data. The word “constrained” is used here to emphasize that during the process of history matching, reconstruction of the corresponding triggering and back fronts (102 and 104 in FIG. 1) that envelop the evolving swarms of micro-seismic cloud is performed. The triggering front 102 is reconstructed while history matching the acquired pressure and rate data during the pressure build-up phase, and the back front 104 is reconstructed while history matching of the pressure data acquired during the pressure fall-off phase.

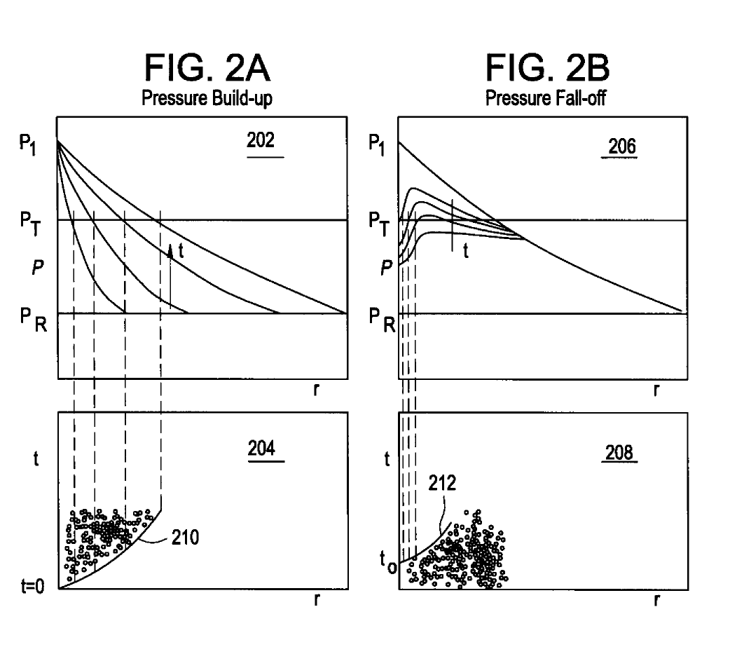

FIG. 2A illustrates a p-r plot (plot of pressure p to distance r) corresponding to t-r plot 204 during the pressure build-up phase. FIG. 2B illustrates a p-r plot 206 and a corresponding t-r plot 208 during a fall-off phase. The figures show the evolution of the triggering front 210 and back front 212 during the build-up and fall-off phases, respectively.

Propagation of a hydraulic fracture is accompanied by creation of new fractures, where p(r,t)≧P_{T}(r). During this process, pre-existing cracks in the reservoir are enhanced. In accordance with some embodiments, an analytic mathematical model that describes the pressure build-up during a variable rate fluid injection and the ensuing advancement of the fluid front followed by pressure fall-off during shut-in, in a dual-porosity, dual-permeability reservoir, is provided for real-time interpretation. The growth of the dominant hydraulic fracture is accounted by a time-dependent skin (a skin refers to a zone of reduced or enhanced permeability around a wellbore). The technique according to some embodiments determines key reservoir parameters that adequately describe flow behavior in a dual porosity reservoir, where the primary porosity φₘ is inter-granular and controlled by deposition and lithification, and the secondary porosity φ_{f} is controlled by fracturing and jointing.

Once the reservoir has been adequately parameterized, a semi-analytic simulator according to some embodiments is used to characterize dynamic flow behavior within the reservoir. One advantage of the simulator is that it quickly converges without gridding challenges or numerical instabilities. Other features of the simulator include one or more of the following:
fracturing in the presence of other wells (vertical, horizontal and deviated) can be studied;
variable flow rates and bottom hole pressure (BHP) can be specified;
wellbore storage and skin can be included;
fractures (natural and induced) can be included;
non-darcy flow is possible;
closed boundary and aquifer support is provided;
multi-phase analysis is provided;
desorption is considered; and
automatic history matching is performed.

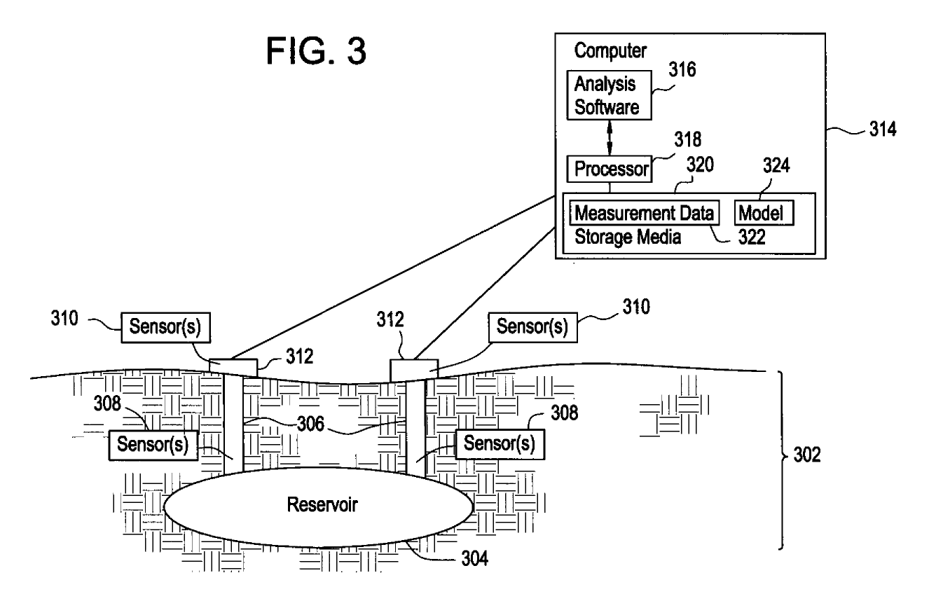

The analysis according to some embodiments can be performed by analysis software (e.g., analysis software 316 executable in a computer 314 as shown in FIG. 3). As further shown in FIG. 3, the computer 314 includes a processor 318 on which the analysis software 316 is executable. The processor 318 is connected to storage media 320, which can be implemented when one or more disk-based storage devices and/or one or more integrated circuit or semiconductor storage devices. The storage media 320 contains measurement data 322 collected by various sensors 308 and 310. The storage media 320 also stores a model 324 that is used by techniques according to some embodiments.

The sensors 308 shown in FIG. 3 are sensors deployed downhole in wellbores 306 that are drilled into a subterranean formation 302. The sensors 310 are earth surface sensors deployed at the earth surface, such as part of wellhead equipment 312. In other implementations, earth surface sensors 310 or downhole sensors 308 may be omitted.

The wellbores 306 intersect a reservoir 304 in the subterranean formation 302. One of the wellbores 306 can be used to produce fluids from the reservoir 304, while another one of the wellbores 306 can be used to inject fluids into the reservoir 304, such as fracturing fluids used for fracturing the reservoir 304 as part of the hydraulic fracturing process.

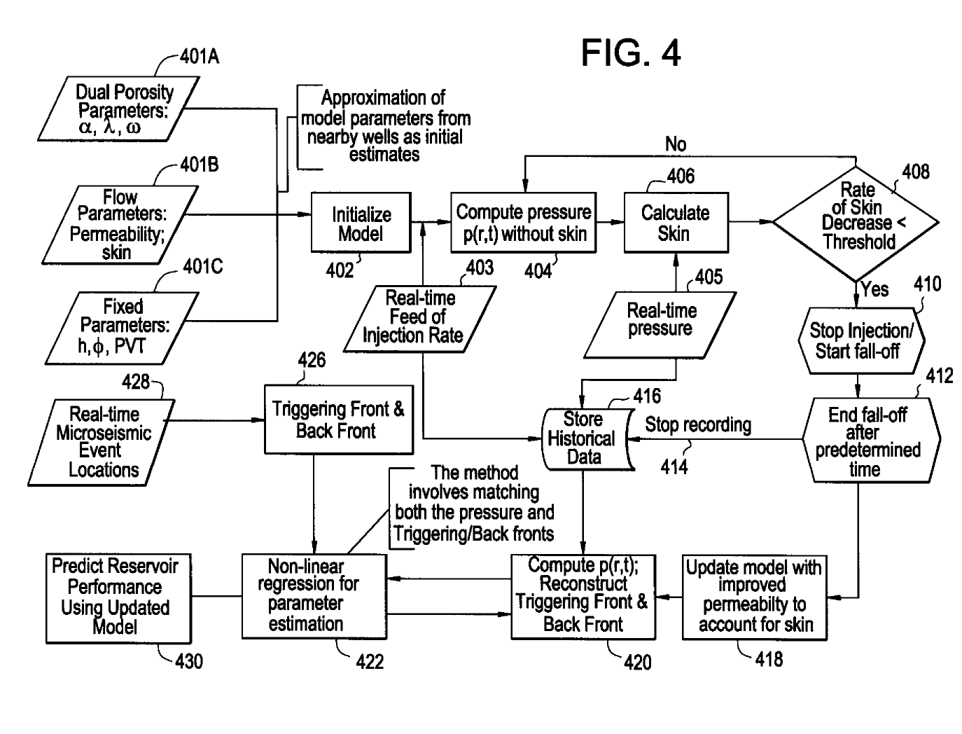

FIG. 4 illustrates a workflow procedure according to an embodiment. A reservoir model is initialized (at 402). The reservoir model is initialized with approximations of various model parameters derived from nearby wells, where such approximations of model parameters are used as initial estimates that are input into the model. The model that is considered according to some embodiments is a model of a subterranean formation that includes at least one wellbore that is located in an infinite homogeneous isotropic medium of uniform thickness. In the model, it is assumed that the formation and fluid properties are independent of pressure, the fluids are of relatively small compressibility, and that gravity effects are negligible.

Reservoir parameters 401A of the model that are initialized include dual porosity parameters including the shape factor (α), transmissivity (λ), and storativity (ω)). In addition, flow parameters 401B for the model that are initialized include the reservoir permeability and skin. Fixed parameters 401C for the model include reservoir thickness (h), porosity (φ), and pressure, volume, and temperature. The initial estimates for the various model parameters can be obtained from one or more of the following: well logs, formation micro-imager (FMI) data, sonic scanner data, nearby micro-seismic data, and so forth.

Next, after initializing (at 402) the model, during a pressure build-up phase of a hydraulic fracturing process in which fracturing fluid is injected, the pressure as a function of time and position, p(r,t), is computed (at 404). To compute p(r,t), real-time injection rate measurement data is acquired (at 403) at the treatment wellbore (the wellbore used to inject fluid) and used as an input. The injection rate is the rate of injection of the fracturing fluid for the hydraulic fracturing operation. The computed pressure includes a fracture pressure p_{fi} (pressure in fractures) and matrix pressure pₘᵢ, (pressure in the reservoir containing the fractures) that are calculated according to Eqs. 21 and 22 (below) during the early stages of the hydraulic fracturing process. The fracture pressure p_{fi} and matrix pressure pₘᵢ are calculated according to Eqs. 10 and 11 (below) in subsequent stages of the hydraulic fracturing process.

The computed pressure is uncorrected for skin. The skin refers to a zone of reduced permeability around a wellbore. Skin can be caused by particles clogging up pores in the reservoir. Real-time wellbore pressure measurement data is acquired (at 405), and a skin calculator (which is part of the analysis software 316 of FIG. 3) is used to calculate (at 406) the skin (according to Eq. 41 below) of the reservoir in real-time at predetermined intervals.

If the rate of skin decrease falls below a predetermined threshold, as determined at 408, a notification can be provided to a well operator to allow the well operator to stop the fracturing job (at 410). Otherwise, the procedure proceeds back to re-perform tasks 404 and 406. The rate of skin decrease falling below the predetermined threshold indicates that the hydraulic fracturing has assisted in increasing the permeability of the reservoir to an extent such that any further hydraulic fracturing may not substantially or effectively enhance further reduced skin.

Once the fracturing fluid injection is stopped (at 410), the pressure fall-off phase is started. The pressure fall-off phase is continued for some predetermined time, during which all real-time data measurement acquisitions are continued. The fall-off phase is ended (at 412) after the predetermined time period. At that point, recording of real-time measurement data is stopped (at 414), and historical data is stored (at 416), where the stored historical data includes measurement data collected during the pressure build-up phase and fall-off phase of the hydraulic fracturing process.

After ending of the pressure fall-off phase, the model is updated (at 418), which includes setting the improved permeability in the invaded zone to account for skin improvement due to hydraulic fracturing. Effectively, the updated model contains the effect of the hydraulic fracturing process that has been performed.

The pressure p(r,t) is then computed (at 420) again, by computing the fracture pressure p_{fi} according to Eq. 33 and the matrix pressure pₘᵢ according to Eq. 34. The computation of the fracture pressure and matrix pressure uses the stored historical information (416) and the updated model. The re-computed fracture pressure p_{fi} and the matrix pressure pₘᵢ, now reflect the improved skin effect resulting from the hydraulic fracturing process.

Also, at 420, while the pressure p(r,t) (including the fracture pressure p_{fi} and the matrix pressure pₘᵢ) is being computed, the triggering front 102 is reconstructed as the calculated p(r,t) exceeds a micro-seismic event activation pressure threshold P_{T}(r) that is essentially the upper bound on a pseudo-random pore pressure function. Similarly, the back front 104 is reconstructed based on declines of treatment well pressures below P_{T}(r).

A parabolic expression, r_{tf}=\sqrt{4πηₐₚt}, for the triggering front 102, is derived by considering the pore pressure perturbations induced by a point source, where ηₐₚ is an apparent hydraulic diffusion coefficient associated with the fracturing process. This expression for the triggering front 102 is then used in conjunction with a volumetric balance to estimate fracture geometry parameters such as fracture width, lateral and vertical extent and fluid loss coefficient, a parameter associated with estimation of fluid loss from the fracture into the surrounding matrix. An expression,

$${r}_{bf} = \sqrt{2 η ( \frac{t}{{t}_{0}} - 1 ) ln ( \frac{t}{t - {t}_{0}} )} ,$$

is derived for the back front 104 that develops during pore pressure relaxation after shutdown (during the pressure fall-off phase), where η is a pore pressure diffusivity constant associated with the established fracture-matrix system.

Non-linear regression is performed (at 422) to update the dual porosity and flow parameters, including transmissivity (λ), storativity (ω), shape factor (α), permeability, and skin. The updated parameters further characterize the updated reservoir model. The volumetric distribution of micro-seismic activity and the volume of fluid injected are used to update the storativity. Also, the algorithm aims to minimize the objective function that incorporates both wellbore pressure and the triggering and back front positions.

In performing the non-linear regression, the reconstructed triggering front and back front are matched to the trigger front and back front derived (at 426) based on real-time micro-seismic event locations (428). The trigger and back fronts derived based on the real-time micro-seismic event locations are considered the measured trigger and back fronts. The micro-seismic event locations (428) are based on seismic data acquired by seismic sensors that are able to measure micro-seismic events induced by the hydraulic fracturing process.

Next, in accordance with some embodiments, performance of a well and the reservoir can be predicted (at 430) using the updated reservoir model. This is accomplished by running a simulator (which can be part of the analysis software 316 of FIG. 3) that uses the updated reservoir model (depicted as 324 in FIG. 3).

The following provides further details regarding various parameters and calculations of pressure, skin, and other variables.

As noted above, storativity (w) is a parameter relating fluid capacitance of the secondary (fracture) porosity to that of the combined system. Classically it is defined as:

$$ω = \frac{{φ}_{f} {c}_{f}}{{φ}_{m} {c}_{m} + {φ}_{f} {c}_{f}} , \qquad ( Eq . 1 )$$

where φₘ=primary porosity (matrix), φ_{f}=secondary porosity (e.g., due to fractures), and cₘ and c_{f} are total compressibilities within the matrix and fracture, respectively.

The primary porosity φₘ will typically be determined from laboratory core analysis (analysis of core samples retrieved from the subterranean formation). Porosity due to fractures and joints φ_{f} can be estimated in the simplest case using the total injected fluid volume distributed in the reservoir and micro-seismic density, taking into account leakoff to the primary matrix. This is particularly easy when the primary matrix has a very low permeability (e.g., a gas shale), the injected fluid is incompressible (e.g., water), and leakoff from fractures to the matrix during injection can be considered negligible. Consider a blocked region full of detected and located micro-seismic events, then in each region of the blocked reservoir i,

$${φ}_{fi} ≅ \frac{{n}_{i} {\int }_{0}^{t} q ( t ) d t}{{NV}_{i}} , \qquad ( Eq . 2 )$$

where ηᵢ is the number of micro-seismic events in block i, Vᵢ is the volume of block i, N is the total number of micro-seismic events, and q(t) is the injection rate. It is also assumed that

$$\begin{matrix}{c}_{m} = {c}_{0} + \frac{{c}_{p} + {S}_{wi} {c}_{w}}{1 - {S}_{wi}} , and & ( Eq . 3 ) \\ {c}_{f} = {c}_{0} , & ( Eq . 4 )\end{matrix}$$

where c₀ is the compressibility of flowing liquid, cₚ is the effective pore compressibility, c_{w} is the compressibility of connate water, and S_{wi} represents the connate water saturation.

Alternatively, the micro-seismic waveforms may be used to define discrete planar fracture surfaces, and then the frequency content of the waveforms can be analyzed to estimate the equivalent radius of the fracture plane. The contributions of individual micro-seismic events to porosity can then be weighted according to the derived fracture area associated with each event. Alternatively, induced porosity may be derived from micro-seismic density weighted by seismic moment determined from the frequency analysis.

Waveforms may be inverted for the moment tensor associated with micro-seismic events. When a sufficient observation network (of sensors) is available, more reliable moment tensor solutions can be obtained with components representing double couple (pure shear), tension and compensated linear vector dipole (CLVD). In these cases, the relative amount of tensile to double couple can be used to further specify the opening of cracks, and the associated induced porosity.

Shape factor (α) is the geometric parameter describing the distribution of a fracture network including anisotropic behavior in a heterogeneous region. The shape factor reflects the geometry of the matrix elements and the shape factor controls the flow between the two porous regions. It generally allows specification of variable fracture spacing and/or width in different directions so it can be used to indicate the proper degree of anisotropy.

As the fracture network or mesh is formed, an interaction with natural fractures causes alternating jogs between almost pure shear fracture along pre-existing natural fractures and induced fractures oriented parallel to the direction of maximum horizontal stress. A large difference in angle between the natural fractures and max stress direction or low stress anisotropy may create more complex fracture networks with less preferential flow direction. One of three methods may be used to characterize the fracture network and estimate the shape factor from micro-seismic data.

The simplest estimation of shape factor may come from knowledge (length versus width) of the overall frac geometry coupled with other knowledge of preferred fluid propagation direction such as from stress anisotropy interpretation.

Another method that involves composite fault phase solutions exploits the observation that just a few characteristic fracture plane orientations typically exist within a hydraulic fracture network. In addition, the mechanism for most of the fracturing events appears to be almost purely double couple allowing the corresponding solutions to be fit to the aggregate data. The method involves extraction of the amplitudes and first motion polarities of the P, S-H and S-V arrivals, and then fitting the rations (e.g., S-H/P) to theoretical double couple solutions as a function of arrival angle (at the receivers). The final step in this method is to assign a characteristic fracture plane orientation to each of the micro-seismic events and compute an overall shape factor utilizing the event locations and orientations. The fracture plane areas, derived from conventional earthquake spectral analysis methods, may also be used in the shape factor calculation as it contributes to the characterization of the fracture network geometry.

Alternatively, a more advanced shape factor estimation may be derived from full moment sensor solutions for individual micro-seismic events when they are reliable (when the sensor network provides sufficient focal sphere coverage). This method then assigns a unique fracture plane location, orientation and area to each micro-seismic event in the characterization of the fracture network and calculation of shape factor.

Transmissivity (λ) is the parameter governing flow between the fractures and the primary matrix defined as,

$$λ = \frac{α {k}_{m} {a}^{2}}{{k}_{e}} , \qquad ( Eq . 5 )$$

where α is the shape factor (geometric parameter for heterogeneous region), kₘ is the permeability of the primary matrix, a is the radius of the well, and kₑ is the effective permeability of anisotropic medium. Transmissivity is deduced from the constrained history matching of the pressure build-up and fall-off data.

The physical model considered in this analysis includes a wellbore located in an infinite homogeneous isotropic medium of uniform thickness. The formation and fluid properties are independent of pressure, the fluids are of relatively small compressibility, and gravity effects are negligible. Quantities of fluid q(t) are continuously injected at r=a over the entire thickness of the reservoir and displaces the in-situ fluids in a piston-like manner, such that a uniform, immobile in-situ fluid saturation exists behind the advancing fluid front. The resulting pressure disturbance is left to diffuse through a semi-infinite homogeneous porous medium. After a specified period, the injection is terminated and the pressure is allowed to recede. The pressure from the diffusivity equation in a naturally fractured formation is described as follows:

For the invaded region (a<r<r_{f}(t)), where r_{f}(t) represents the advancing fluid front over time t of injected fluids:

$$\begin{matrix}{φ}_{f} {c}_{f} \frac{\partial {p}_{fi}}{\partial t} + {φ}_{m} {c}_{m} \frac{\partial {p}_{mi}}{\partial t} = \frac{{k}_{fi}}{{μ}_{w}} ( \frac{{\partial }^{2} {p}_{fi}}{\partial {r}^{2}} + \frac{1}{r} \frac{\partial {p}_{fi}}{\partial r} ) , \\ and & ( Eq . 6 ) \\ {φ}_{m} {c}_{m} \frac{\partial {p}_{mi}}{\partial t} = α \frac{{k}_{mi}}{{μ}_{w}} ( {p}_{fi} - {p}_{mi} ) . & ( Eq . 7 )\end{matrix}$$

The invaded region is the region in which injected fluid extends. For the uninvaded region (r>r_{f} (t)):

$$\begin{matrix}{φ}_{f} {c}_{f} \frac{\partial {p}_{fu}}{\partial t} + {φ}_{m} {c}_{m} \frac{\partial {p}_{mu}}{\partial t} = \frac{{k}_{fu}}{{μ}_{o}} ( \frac{{\partial }^{2} {p}_{fu}}{\partial {r}^{2}} + \frac{1}{r} \frac{\partial {p}_{fu}}{\partial r} ) , \\ and & ( Eq . 8 ) \\ {φ}_{m} {c}_{m} \frac{\partial {p}_{mu}}{\partial t} = α \frac{{k}_{mu}}{{μ}_{o}} ( {p}_{fu} - {p}_{mu} ) . & ( Eq . 9 )\end{matrix}$$

The uninvaded region is the region of the reservoir that the injected fluid does not reach. In these equations, p_{fi} and pₘᵢ represent the fracture and matrix pressures in the flooded zones whereas, p_{fu} and pₘᵤ, denote the fracture and matrix pressures in the oil zone. Here, matrix diffusivities of the invaded and uninvaded regions are defined, respectively, by

$${η}_{mi} = \frac{{k}_{mi}}{{μ}_{w} {φ}_{m} {c}_{m}} = \frac{{k}_{m}^{α} {k}_{rw} ( 1 - {S}_{or} )}{{μ}_{w} {φ}_{m} {c}_{m}} , and$$

$${η}_{mu} = \frac{{k}_{mu}}{{μ}_{o} {φ}_{m} {c}_{m}} = \frac{{k}_{m}^{α} {k}_{ro} ( 1 - {S}_{ω i} )}{{μ}_{o} {φ}_{m} {c}_{m}} .$$

Similarly, η_{fi} and η_{fu} denote the fracture diffusivities of the invaded and uninvaded regions defined respectively by

$${η}_{fi} = \frac{{k}_{f i}}{{μ}_{w} {φ}_{f} {c}_{f}} = \frac{{k}_{fi}^{α} {k}_{rw} ( 1 - {S}_{or} )}{{μ}_{w} {φ}_{f} {c}_{f}} and$$

$${η}_{fu} = \frac{{k}_{fu}}{{μ}_{o} {φ}_{f} {c}_{f}} = \frac{{k}_{fu}^{α} {k}_{ro} ( 1 - {S}_{ω i} )}{{μ}_{o} {φ}_{f} {c}_{f}} .$$

Note that the fracture absolute permeability in the invaded zone, k_{fi}^{a}, is different from that of the uninvaded zone, k_{fu}^{a}, in order to model the variable mechanical skin.

The boundary conditions are at

$$r = a , \frac{\partial {p}_{f} ( a , t )}{\partial r} = - ( \frac{{u}_{w}}{{k}_{ft}} ) q ( t ) ,$$

and at the moving interface r=r_{f}(t), p_{fi}{r_{f}(t),t}=p_{fu}{r_{f}(t),t}, pₘᵢ{r_{f}(t),t}=pₘᵤ{r_{f}(t),t} and

$$[ \frac{\partial {p}_{fi} \{ {r}_{f} ( t ) , t \}}{\partial r} ] ( \frac{{μ}_{w}}{{k}_{fi}} ) = [ \frac{\partial {p}_{fu} \{ {r}_{f} ( t ) , t \}}{\partial r} ] ( \frac{{u}_{o}}{{k}_{fu}} ) .$$

Here i and u denote the invaded and uninvaded regions. The initial condition p_{f}(r,0)=pₘ(r,0)=φ(r)=p_{I}. The above solves the pressure build-up phase of the problem during injection. Fluid injection is terminated at t=t₀. The radial pressure profile at t=t₀, obtained from the pressure build up solution is used as the initial condition to solve the pressure fall-off problem. The invaded and uninvaded region solutions for the pressure build-up and fall-off phases are given below.

The following describes solutions during the pressure build-up phase for the invaded region. The general solutions for the fracture and matrix pressure, with the exception of very early times, are given by

$$\begin{matrix}{p}_{fi} = \frac{2}{( {r}_{f}^{2} ( t ) - {a}^{2} ) ( 1 + \frac{{k}_{mi} {η}_{fi}}{{k}_{fi} {η}_{mi}} )} {\int }_{0}^{t} ( {A}_{f} ( τ ) + \frac{{k}_{mi} {η}_{fi}}{{k}_{fi} {η}_{mi}} {A}_{m} ( τ ) + \frac{{k}_{mi} {η}_{fi}}{{k}_{fi} {η}_{mi}} ( {A}_{f} ( τ ) - {A}_{m} ( τ ) ) {e}^{- {αη}_{mi} ( 1 + \frac{{k}_{mi} {η}_{fi}}{{k}_{fi} {η}_{mi}} ) ( t - τ )} ) d τ ++ \frac{{π}^{2}}{2} {\sum }_{n = 1}^{∞} \frac{{ξ}_{n}^{2} {J}_{1}^{2} \{ {ξ}_{n} {r}_{f} ( t ) \} {κ}_{n} ( {ξ}_{n} r )}{[ {J}_{1}^{2} ( {ξ}_{n} a ) - {J}_{1}^{2} \{ {ξ}_{n} {r}_{f} ( t ) \} ]} {e}^{- {ϑ}_{nn} ( t )} [ {\int }_{0}^{t} {e}^{- {ϑ}_{nn} ( τ )} ( {B}_{f} ( {ξ}_{n} , τ ) cosh ( α \sqrt{\frac{{k}_{mi}}{{k}_{fi}} {η}_{mi} {η}_{fi}} ( t - τ ) ) ++ \sqrt{\frac{{k}_{mi} {η}_{fi}}{{k}_{fi} {η}_{mi}}} sinh ( α \sqrt{\frac{{k}_{mi}}{{k}_{fi}} {η}_{mi} {η}_{fi}} ( t - τ ) ) [ {B}_{m} ( {ξ}_{n} , τ ) + ( α ( {ξ}_{n}^{2} + α \frac{{k}_{mi}}{{k}_{fi}} ) - {αη}_{mi} ) {\overline{p}}_{mi}^{( k - 1 )} ( {ξ}_{n} , τ ) ] ) d τ ] + pI \\ and & ( Eq . 10 ) \\ {p}_{mi}^{( k )} = \frac{2}{( {r}_{f}^{2} ( t ) - {a}^{2} ) ( 1 + \frac{{k}_{mi} {η}_{fi}}{{k}_{fi} {η}_{mi}} )} {\int }_{0}^{t} ( {A}_{f} ( τ ) + \frac{{k}_{mi} {η}_{fi}}{{k}_{fi} {η}_{mi}} {A}_{m} ( τ ) - ( {A}_{f} ( τ ) - {A}_{m} ( τ ) ) {e}^{- {αη}_{mi} ( 1 + \frac{{k}_{mi} {η}_{fi}}{{k}_{fi} {η}_{mi}} ) ( t - τ )} ) d τ ++ \frac{{π}^{2}}{2} {\sum }_{n = 1}^{∞} \frac{{ξ}_{n}^{2} {J}_{1}^{2} \{ {ξ}_{n} {r}_{f} ( t ) \} {κ}_{n} ( {ξ}_{n} r )}{[ {J}_{1}^{2} ( {ξ}_{n} a ) - {J}_{1}^{2} \{ {ξ}_{n} {r}_{f} ( t ) \} ]} {e}^{- {ϑ}_{nn} ( t )} [ {\int }_{0}^{t} {e}^{- {ϑ}_{nn} ( τ )} ( \sqrt{\frac{{k}_{fi} {η}_{mi}}{{k}_{mi} {η}_{fi}}} {B}_{f} ( {ξ}_{n} , τ ) sinh ( α \sqrt{\frac{{k}_{mi}}{{k}_{fi}} {η}_{mi} {η}_{fi}} ( t - τ ) ) ++ cosh ( α \sqrt{\frac{{k}_{mi}}{{k}_{fi}} {η}_{mi} {η}_{fi}} ( t - τ ) ) [ {B}_{m} ( {ξ}_{n} , τ ) + ( α ( {ξ}_{n}^{2} + α \frac{{k}_{mi}}{{k}_{fi}} ) - {αη}_{mi} ) {\overline{p}}_{mi}^{( k - 1 )} ( {ξ}_{n} , τ ) ] ) d τ ] + pI & ( Eq . 11 )\end{matrix}$$

where the subscript i denotes the invaded region a≦r≦r_{f}(t) and

$$\begin{matrix}{A}_{f} ( t ) = \frac{q ( t ) {p}_{f} \{ {r}_{f} ( t ) \}}{2 π h φ ( {S}_{w} - {S}_{wi} )} + \frac{1}{{φ}_{f} {c}_{f}} \{ aq ( t ) - {r}_{f} ( t ) {ψ}_{{r}_{f}} ( t ) \} , & ( Eq . 12 ) \\ {A}_{m} ( t ) = \frac{q ( t ) {p}_{m} \{ {r}_{f} ( t ) \}}{2 π h φ ( {S}_{w} - {S}_{wi} )} , & ( Eq . 13 ) \\ {B}_{f} ( {ξ}_{n} , t ) = \frac{q ( t ) {κ}_{n} \{ {ξ}_{n} {r}_{f} ( t ) \} {p}_{f} \{ {r}_{f} ( t ) \}}{2 π h φ ( {S}_{w} - {S}_{wi} )} + \frac{{2}_{q} ( t )}{{πφ}_{f} {c}_{f} {ξ}_{n}} - \frac{2 {J}_{1} ( {ξ}_{n} a ) {ψ}_{{r}_{f}} ( t )}{{πφ}_{f} {c}_{f} {ξ}_{n} {J}_{1} \{ {ξ}_{n} {r}_{f} ( t ) \}} , & ( Eq . 14 ) \\ {B}_{m} ( {ξ}_{n} , t ) = \frac{q ( t ) {κ}_{n} \{ {ξ}_{n} {r}_{f} ( t ) \} {p}_{m} \{ {r}_{f} ( t ) \}}{2 π h φ ( {S}_{w} - {S}_{wi} )} , & ( Eq . 15 )\end{matrix}$$

where Kₙ(ξₙr)=Y₀(ξₙr)J₁(ξₙa)−J₀(ξₙr)Y₁(ξₙa). The set of eigenvalues ξₙ, which are time dependent, are the positive roots of the transcendental equation J₁(ξₙa)Y₁{ξₙr_{f}(t)}−Y₁(ξₙa)J₁{ξₙr_{f}(t)}=0, n=1,2 . . . :

$$\begin{matrix}{ϑ}_{nn} ( t ) = {\int }_{0}^{t} {ϖ}_{nn}^{f} ( τ ) d τ , & ( Eq . 16 ) \\ {ϖ}_{pn}^{f} ( t ) = {η}_{f} ( {ξ}_{n}^{2} + α \frac{{k}_{mi}}{{k}_{fi}} ) {δ}_{p}^{n} - Ω ( {ξ}_{n} , {ξ}_{p} , t ) , & ( Eq . 17 ) \\ {ϖ}_{pn}^{m} ( t ) = {αη}_{mi} {δ}_{p}^{n} - Ω ( {ξ}_{n} , {ξ}_{p} , t ) , \\ where {δ}_{p}^{n} = \{ \begin{matrix}0 & p \neq n \\ 1 & p = n\end{matrix} \} & ( Eq . 18 )\end{matrix}$$

is the Kronecker delta function. Also,

$$Ω ( {ξ}_{n} , {ξ}_{p} , t ) = \frac{{π}^{2} {ξ}_{p}^{2} {J}_{1}^{2} \{ {ξ}_{p} {r}_{f} ( t ) \}}{2 \{ {J}_{1}^{2} ( {ξ}_{p} a ) - {J}_{1}^{2} \{ {ξ}_{p} {r}_{f} ( t ) \} \}} {\int }_{a}^{{r}_{f} ( t )} r {κ}_{p} ( {ξ}_{p} r ) \frac{\partial {κ}_{n} ( {ξ}_{n} r )}{\partial t} d r . \qquad ( Eq . 19 )$$

The advancing fluid front is given by

$${r}_{f}^{2} ( t ) = {a}^{2} + \frac{{\int }_{0}^{t} q ( τ ) d τ}{π h φ ( {S}_{w} - {S}_{wi} )} , \qquad ( Eq . 20 )$$

where h is the thickness of the reservoir, S_{w} is the water saturation and S_{ωi} the initial water saturation. Note that an iterative procedure is performed to evaluate the fracture and matrix pressures, where k represents the iteration counter.

During very early times when the fluid front of the injected fluids is still close to the wellbore a good iterative approximation of the fractures and matrix pressures p_{fi} and pₘᵢ can be made. The solutions are given by

$$\begin{matrix}{p}_{fi}^{( j )} = \frac{2}{( {r}_{f}^{2} ( t ) - {a}^{2} ) ( 1 + \frac{{k}_{m} , {η}_{fi}}{{k}_{f} , {η}_{mi}} )} \times \times {\int }_{0}^{t} ( {A}_{f} ( τ ) + \frac{{k}_{mi} {η}_{fi}}{{k}_{fi} {η}_{mi}} {A}_{m} ( τ ) + \frac{{k}_{mi} {η}_{fi}}{{k}_{fi} {η}_{mi}} ( {A}_{f} ( τ ) - {A}_{m} ( τ ) ) {e}^{{αη}_{mi} ( 1 + \frac{{k}_{mi} {η}_{fi}}{{k}_{fi} {η}_{mi}} ) ( l - τ )} ) d τ ++ \frac{{π}^{2}}{2} {\sum }_{n = 1}^{∞} \frac{{ξ}_{n}^{2} {J}_{1}^{2} \{ {ξ}_{n} {r}_{f} ( {t}_{0} ) \} {𝒦}_{n} ( {ξ}_{n} r )}{[ {J}_{1}^{2} ( {ξ}_{n} a ) - {J}_{1}^{2} \{ {ξ}_{n} {r}_{f} ( {t}_{0} ) \} ]} [ {\int }_{0}^{t} ( cosh ( α \sqrt{\frac{{k}_{mi}}{{k}_{fi}} {η}_{mi} {η}_{fi}} ( t - τ ) ) [ {B}_{f} ( {ξ}_{n} , τ ) - {C}_{f}^{( j - 1 )} ( {ξ}_{n} , τ ) ] ++ \sqrt{\frac{{k}_{mi} {η}_{fi}}{{k}_{fi} {η}_{mi}}} sinh ( α \sqrt{\frac{{k}_{mi}}{{k}_{fi}} {η}_{mi} {η}_{fi}} ( t - τ ) ) [ {B}_{m} ( {ξ}_{n} , τ ) - {C}_{m}^{( k - 1 ) / A} ( {ξ}_{n} , τ ) ++ ( α ( {ξ}_{n}^{2} + α \frac{{k}_{mi}}{{k}_{fi}} ) - {αη}_{mi} ) {\overline{p}}_{mi}^{( k - 1 )} ( {ξ}_{n} , τ ) ] ) {e}^{- {ϑ}_{n , n} ( t )} d τ ] + {p}_{I} , \\ and & ( Eq . 21 ) \\ {p}_{mi}^{( k )} = \frac{2}{( {r}_{f}^{2} ( t ) - {a}^{2} ) ( 1 + \frac{{k}_{mi} {η}_{fi}}{{k}_{fi} {η}_{mi}} )} {\int }_{0}^{t} ( {A}_{f} ( τ ) + \frac{{k}_{mi} {η}_{fi}}{{k}_{fi} {η}_{mi}} {A}_{m} ( τ ) - ( {A}_{f} ( τ ) - {A}_{m} ( τ ) ) {e}^{- {αη}_{mi} ( 1 + \frac{{k}_{mi} {η}_{fi}}{{k}_{fi} {η}_{mi}} ) ( t - r )} ) d τ ++ \frac{{π}^{2}}{2} {\sum }_{n = 1}^{∞} \frac{{ξ}_{n}^{2} {J}_{1}^{2} \{ {ξ}_{n} {r}_{f} ( {t}_{0} ) \} {𝒦}_{n} ( {ξ}_{n} r )}{[ {J}_{1}^{2} ( {ξ}_{n} a ) - {J}_{1}^{2} \{ {ξ}_{n} {r}_{f} ( {t}_{0} ) \} ]} \times \times [ {\int }_{0}^{t} ( \sqrt{\frac{{k}_{fi} {η}_{mi}}{{k}_{mi} {η}_{fi}}} sinh ( α \sqrt{\frac{{k}_{mi}}{{k}_{fi}} {η}_{mi} {η}_{fi}} ( t - τ ) ) [ {B}_{f} ( {ξ}_{n} , τ ) - {C}_{f}^{( j - 1 )} ( {ξ}_{n} , τ ) ] ++ cosh ( α \sqrt{\frac{{k}_{mi}}{{k}_{fi}} {η}_{mi} {η}_{fi}} ( t - τ ) ) [ {B}_{m} ( {ξ}_{n} , τ ) - {C}_{m}^{( k - 1 )} ( {ξ}_{n} , τ ) ++ ( α ( {ξ}_{n}^{2} + α \frac{{k}_{mi}}{{k}_{fi}} ) - {αη}_{mi} ) {\overline{p}}_{mi}^{( k - 1 )} ( {ξ}_{n} , τ ) ] ) {e}^{- {ϑ}_{n , n} ( t )} d τ ] + {p}_{I} , \\ where & ( Eq . 22 ) \\ {C}_{f}^{( j - 1 )} ( {ξ}_{n} , t ) = \{ \begin{matrix}0 & j = 0 \\ {\sum }_{p = 1}^{∞} {ϖ}_{pn}^{f} ( t ) {\overline{p}}_{fi}^{( j - 1 )} ( {ξ}_{p} , t ) p \neq n & j = 1 , 2 , … ,\end{matrix} \\ and & ( Eq . 23 ) \\ {C}_{m}^{( k - 1 )} ( {ξ}_{n} , t ) = \{ \begin{matrix}0 & k = 0 \\ {\sum }_{p = 1}^{∞} {ϖ}_{pn}^{m} ( t ) {\overline{p}}_{mi}^{( k - 1 )} ( {ξ}_{p} , t ) p \neq n & k = 1 , 2 , … ,\end{matrix} & ( Eq . 24 )\end{matrix}$$

Here, j and k are the iteration counters.

The following describes the solutions during pressure build-up for the uninvaded region. The general solutions for the fracture pressure and the matrix pressure are given respectively by:

$$\begin{matrix}{p}_{fu}^{( j )} = {e}^{- {αη}_{mu} t} {\int }_{0}^{∞} \frac{{ϛ𝒢}_{0} ( ϛ r )}{[ {J}_{1}^{2} \{ ϛ {r}_{f} ( t ) \} + {Y}_{1}^{2} \{ ϛ {r}_{f} ( t ) \} ]} \frac{{λ}_{1} ( ϛ ) {λ}_{2} ( ϛ )}{{λ}_{2} ( ϛ ) - {λ}_{1} ( ϛ )} \times \times {\int }_{0}^{t} ( ( \frac{{e}^{{λ}_{2} ( ϛ ) ( t - r )}}{{λ}_{1} ( ϛ )} - \frac{{e}^{{λ}_{1} ( ϛ ) ( t - τ )}}{{λ}_{2} ( ϛ )} ) ( {C}_{f}^{( j )} ( ϛ , τ ) + {Ξ}_{f}^{( j - 1 )} ( ϛ , τ ) ) + \frac{1}{{αη}_{mu}} ( {e}^{{λ}_{1} ( ϛ ) ( t - τ )} - {e}^{{λ}_{2} ( ϛ ) ( t - τ )} ) ( {C}_{m}^{( k )} ( ϛ , τ ) + {Ξ}_{m}^{( k - 1 )} ( ϛ , τ ) ) ) d τ d ϛ + {p}_{I} & ( Eq . 25 ) \\ {p}_{mu}^{( k )} = {e}^{- {αη}_{mu} t} {\int }_{0}^{∞} \frac{{ϛ𝒢}_{0} ( ϛ r )}{[ {J}_{1}^{2} \{ ϛ {r}_{f} ( t ) \} + {Y}_{1}^{2} \{ ϛ {r}_{f} ( t ) \} ]} \frac{{λ}_{1} ( ϛ ) {λ}_{2} ( ϛ )}{{λ}_{2} ( ϛ ) - {λ}_{1} ( ϛ )} \times \times {\int }_{0}^{t} ( ( \frac{{e}^{{λ}_{1} ( ϛ ) ( t - r )}}{{λ}_{1} ( ϛ )} - \frac{{e}^{{λ}_{2} ( ϛ ) ( t - τ )}}{{λ}_{2} ( ϛ )} ) ( {C}_{m}^{( k )} ( ϛ , τ ) + {Ξ}_{m}^{( k - 1 )} ( ϛ , τ ) ) , + \frac{{αη}_{mu}}{{λ}_{1} ( ϛ ) {λ}_{2} ( ϛ )} ( {e}^{{λ}_{2} ( ϛ ) ( t - τ )} - {e}^{{λ}_{1} ( ϛ ) ( t - τ )} ) ( {C}_{f}^{( j )} ( ϛ , τ ) + {Ξ}_{f}^{( j - 1 )} ( ϛ , τ ) ) ) d τ d ϛ + {p}_{I} , & ( Eq . 26 )\end{matrix}$$

where the subscript u denotes the uninvaded region, r_{f}(t)≦r≦∞, and the functions C_{f}(ç,t), Cₘ(ç,t), λ₁(ç) and λ₂(ç) are defined by the following equations:

$$\begin{matrix}{C}_{f} ( ϛ , t ) = [ \frac{2 {ψ}_{rj} ( t )}{{πφ}_{f} {c}_{f} ϛ} - \frac{q ( t ) {𝒢}_{0} \{ ϛ {r}_{f} ( t ) \} {p}_{f} \{ {r}_{f} ( t ) \}}{2 π h φ ( {S}_{w} - {S}_{wi} )} ] {e}^{{αη}_{mu} t} , & ( Eq . 27 ) \\ {C}_{m} ( ϛ , t ) = - \frac{q ( t ) {𝒢}_{0} \{ ϛ {r}_{f} ( t ) \} {p}_{m} \{ {r}_{f} ( t ) \}}{2 π h φ ( {S}_{w} - {S}_{wi} )} {e}^{{αη}_{mu} t} , & ( Eq . 28 ) \\ {Ξ}_{f}^{( j - 1 )} ( ϛ , t ) = {e}^{{αη}_{mu} t} {\int }_{0}^{∞} \frac{ζ {\overline{p}}_{fu}^{( j - 1 )} ( ζ , t )}{[ {J}_{1}^{2} \{ ζ {r}_{f} ( t ) \} + {Y}_{1}^{2} \{ ζ {r}_{f} ( t ) \} ]} {\int }_{{r}_{f} ( t )}^{∞} r {𝒢}_{0} ( ζ r ) \frac{\partial {𝒢}_{0} ( ϛ r )}{\partial t} d r d ζ , & ( Eq . 29 ) \\ {Ξ}_{m}^{( k - 1 )} ( ϛ , t ) = {e}^{{αη}_{mu} t} {\int }_{0}^{∞} \frac{ζ {\overline{p}}_{mu}^{( k - 1 )} ( ζ , t )}{[ {J}_{1}^{2} \{ ζ {r}_{f} ( t ) \} + {Y}_{1}^{2} \{ ζ {r}_{f} ( t ) \} ]} {\int }_{{r}_{f} ( t )}^{∞} r {𝒢}_{0} ( ζ r ) \frac{\partial {𝒢}_{0} ( ϛ r )}{\partial t} d r d ζ , & ( Eq . 30 ) \\ {λ}_{1} ( ϛ ) = \frac{1}{2} ( {αη}_{mu} - {η}_{fu} ( {ϛ}^{2} + α \frac{{k}_{mu}}{{k}_{fu}} ) - \sqrt{{[ {η}_{fu} ( {ϛ}^{2} + α \frac{{k}_{mu}}{{k}_{fu}} ) - {αη}_{mu} ]}^{2} + 4 {α}^{2} \frac{{k}_{mu}}{{k}_{fu}} {η}_{fu} {η}_{mu}} ) . \\ and & ( Eq . 31 ) \\ {λ}_{2} ( ϛ ) = \frac{1}{2} ( {αη}_{mu} - {η}_{fu} ( {ϛ}^{2} + α \frac{{k}_{mu}}{{k}_{fu}} ) + \sqrt{{[ {η}_{fu} ( {ϛ}^{2} + α \frac{{k}_{mu}}{{k}_{fu}} ) - {αη}_{mu} ]}^{2} + 4 {α}^{2} \frac{{k}_{mu}}{{k}_{fu}} {η}_{fu} {η}_{mu}} ) . & ( Eq . 32 )\end{matrix}$$

Note the fracture and matrix pressure solutions are to be used in an iterative scheme. To start the iteration at j=k=1, we assume Ξ_{f}⁽⁰⁾(ç, t)=Ξₘ⁽⁰⁾(ç, t)=0 and for subsequent iterations, Ξ_{f}^{(j-1)} and Ξₘ^{k-1} are given by Eqs. 29 and 30, respectively. At the interface r=r_{f}(t), between the invaded and uninvaded regions, matching the fracture and matrix pressure solutions of the invaded and uninvaded regions, four integral equations with three unknowns are obtained: the fracture pressure p_{f}{r_{f}(t), t}, the matrix pressure pₘ{r_{f}(t), t} and the flux ψr_{f}(t). The parameters p_{f}{,r_{f}(t), t}, pₘ{r_{f}(t), t} and ψ_{rf}(t) deduced from these equations can then be used in the general solutions to obtain the fracture and matrix pressures as a function of r and t.

The following describes solutions during the pressure fall-off phase.

Fluid injection is terminated at t=t₀ and the interface between the invaded and uninvaded regions at r=r_{f}(t₀) is static and is obtained from

$${r}_{f}^{2} ( {t}_{0} ) = {a}^{2} + \frac{{\int }_{0}^{{t}_{0}} q ( τ ) d r}{π h φ ( {S}_{2} - {S}_{wi} )} .$$

The boundary conditions at the interface are p_{fi}{r_{f}(t₀),t}=p_{fu}{f_{f}(t₀), t},pₘᵢ{r_{f}(t₀), t} and

$$[ \frac{\partial {p}_{fi} \{ {r}_{f} ( {t}_{o} ) , t \}}{\partial r} ] ( \frac{{u}_{w}}{{k}_{fi}} ) = [ \frac{\partial {p}_{fu} \{ {r}_{f} ( {t}_{o} ) , t \}}{\partial r} ] ( \frac{{u}_{o}}{{k}_{fu}} ) .$$

The initial condition at t=t₀, start time of the pressure fall-off phase, is obtained from the pressure build-up solutions, which are:

$${p}_{f} ( r , {t}_{0} ) = \{ \begin{matrix}{p}_{fi} ( r , {t}_{0} ) & a \leq r \leq {r}_{f} ( {t}_{0} ) \\ {p}_{fu} ( r , {t}_{0} ) & r \geq {r}_{f} ( {t}_{0} ) ,\end{matrix} \\ and \\ {p}_{m} ( r , {t}_{0} ) = \{ \begin{matrix}{p}_{mi} ( r , {t}_{0} ) & a \leq r \leq {r}_{f} ( {t}_{0} ) \\ {p}_{mu} ( r , {t}_{0} ) & r \geq {r}_{f} ( {t}_{0} ) .\end{matrix}$$

For the invaded region, the solutions in Laplace domain are:

$$\begin{matrix}{\overline{p}}_{fi} = \frac{2}{( {r}_{f}^{2} ( {t}_{0} ) - {a}^{2} )} \times \times [ \frac{α \frac{{k}_{mi}}{{k}_{fi}} {η}_{fi} {\int }_{a}^{{r}_{f} ( {t}_{0} )} {up}_{mi} ( u , {t}_{0} ) d u}{s ( s + {αη}_{mi} ( 1 + \frac{{k}_{mi} {η}_{fi}}{{k}_{fi} {η}_{mi}} ) )} + \frac{( s + {αη}_{mi} ) {\int }_{a}^{{r}_{f} ( {t}_{0} )} {up}_{fi} ( u , {t}_{0} ) d u}{s ( s + {αη}_{mi} ( 1 + \frac{{k}_{mi} {η}_{fi}}{{k}_{fi} {η}_{mi}} ) )} - \frac{{r}_{f} ( {t}_{0} )}{{φ}_{f} {c}_{f}} \frac{( s + {αη}_{mi} ) {\overline{ψ}}_{{r}_{f}} ( s )}{s ( s + {αη}_{mi} ( 1 + \frac{{k}_{mi} {η}_{fi}}{{k}_{fi} {η}_{mi}} ) )} ] ++ \frac{{π}^{2}}{2} α \frac{{k}_{mi}}{{k}_{fi}} {η}_{fi} {\sum }_{n = 1}^{∞} \frac{{ξ}_{n}^{2} {J}_{1}^{2} \{ {ξ}_{n} {r}_{f} ( {t}_{0} ) \} {𝒦}_{n} ( {ξ}_{n} r )}{[ {J}_{1}^{2} ( {ξ}_{n} a ) - {J}_{1}^{2} \{ {ξ}_{n} {r}_{f} ( {t}_{0} ) \} ]} \frac{{\int }_{α}^{{r}_{f} ( {t}_{0} )} {p}_{mi} ( u , {t}_{0} ) u {𝒦}_{0} ( {ξ}_{n} u ) d u}{s [ s + {αη}_{mi} ( 1 + \frac{{k}_{mi} {η}_{fi}}{{k}_{fi} {η}_{mi}} ) ] + {η}_{fi} {ξ}_{n}^{2} ( s + {αη}_{mi} )} ++ \frac{{π}^{2}}{2} {\sum }_{n = 1}^{∞} \frac{{ξ}_{n}^{2} {J}_{1}^{2} \{ {ξ}_{n} {r}_{f} ( {t}_{0} ) \} {𝒦}_{n} ( {ξ}_{n} r )}{[ {J}_{1}^{2} ( {ξ}_{n} a ) - {J}_{1}^{2} \{ {ξ}_{n} {r}_{f} ( {t}_{0} ) \} ]} \frac{( s + {αη}_{mi} ) {\int }_{α}^{{r}_{f} ( {t}_{0} )} {p}_{fi} ( u , {t}_{0} ) u {𝒦}_{0} ( {ξ}_{n} u ) d u}{s [ s + {αη}_{mi} ( 1 + \frac{{k}_{mi} {η}_{fi}}{{k}_{fi} {η}_{mi}} ) ] + {η}_{fi} {ξ}_{n}^{2} ( s + {αη}_{mi} )} -- \frac{π}{{φ}_{f} {c}_{f}} {\sum }_{n = 1}^{∞} \frac{{ξ}_{n} {J}_{1} \{ {ξ}_{n} {r}_{f} ( {t}_{0} ) \} {J}_{1} ( {ξ}_{n} a ) {𝒦}_{n} ( {ξ}_{n} r )}{[ {J}_{1}^{2} ( {ξ}_{n} a ) - {J}_{1}^{2} \{ {ξ}_{n} {r}_{f} ( {t}_{0} ) \} ]} \frac{( s + {αη}_{mi} ) {\overline{ψ}}_{{r}_{f}} ( s )}{s [ s + {αη}_{mi} ( 1 + \frac{{k}_{mi} {η}_{fi}}{{k}_{fi} {η}_{mi}} ) ] + {η}_{fi} {ξ}_{n}^{2} ( s + {αη}_{mi} )} , \\ and & ( Eq . 33 ) \\ {\overline{p}}_{mi} = \frac{{p}_{mi} ( r , {t}_{0} )}{s + {αη}_{mi}} + \frac{2 {αη}_{mi}}{( {r}_{f}^{2} ( {t}_{0} ) - {a}^{2} )} [ \frac{α \frac{{k}_{mi}}{{k}_{fi}} {η}_{fi} {\int }_{a}^{{r}_{f} ( {t}_{0} )} {up}_{mi} ( u , {t}_{0} ) d u}{s ( s + {αη}_{mi} ) ( s + {αη}_{mi} ( 1 + \frac{{k}_{mi} {η}_{fi}}{{k}_{fi} {η}_{mi}} ) )} + \frac{{\int }_{a}^{{r}_{f} ( {t}_{0} )} {up}_{fi} ( u , {t}_{0} ) d u}{s ( s + {αη}_{mi} ( 1 + \frac{{k}_{mi} {η}_{fi}}{{k}_{fi} {η}_{mi}} ) )} -- \frac{{r}_{f} ( {t}_{0} )}{{φ}_{f} {c}_{f}} \frac{{\overline{ψ}}_{{r}_{f}} ( s )}{s ( s + {αη}_{mi} ( 1 + \frac{{k}_{mi} {η}_{fi}}{{k}_{fi} {η}_{mi}} ) )} ] ++ \frac{{π}^{2}}{2} {αη}_{mi} {\sum }_{n = 1}^{∞} \frac{{ξ}_{n}^{2} {J}_{1}^{2} \{ {ξ}_{n} {r}_{f} ( {t}_{0} ) \} {𝒦}_{n} ( {ξ}_{n} r )}{[ {J}_{1}^{2} ( {ξ}_{n} a ) - {J}_{1}^{2} \{ {ξ}_{n} {r}_{f} ( {t}_{0} ) \} ]} \frac{{\int }_{α}^{{r}_{f} ( {t}_{0} )} {p}_{fi} ( u , {t}_{0} ) u {𝒦}_{0} ( {ξ}_{n} u ) d u}{s [ s + {αη}_{mi} ( 1 + \frac{{k}_{mi} {η}_{fi}}{{k}_{fi} {η}_{mi}} ) ] + {η}_{fi} {ξ}_{n}^{2} ( s + {αη}_{mi} )} ++ \frac{{π}^{2}}{2} α \frac{{k}_{mi}}{{k}_{fi}} {η}_{fi} {\sum }_{n = 1}^{∞} \frac{{ξ}_{n}^{2} {J}_{1}^{2} \{ {ξ}_{n} {r}_{f} ( {t}_{0} ) \} {𝒦}_{n} ( {ξ}_{n} r )}{[ {J}_{1}^{2} ( {ξ}_{n} a ) - {J}_{1}^{2} \{ {ξ}_{n} {r}_{f} ( {t}_{0} ) \} ]} \frac{{\int }_{α}^{{r}_{f} ( {t}_{0} )} {p}_{mi} ( u , {t}_{0} ) u {𝒦}_{0} ( {ξ}_{n} u ) d u}{( s + {αη}_{mi} ) ( s [ s + {αη}_{mi} ( 1 + \frac{{k}_{mi} {η}_{fi}}{{k}_{fi} {η}_{mi}} ) ] + {η}_{fi} {ξ}_{n}^{2} ( s + {αη}_{mi} ) )} -- \frac{{παη}_{mi}}{{φ}_{f} {c}_{f}} {\sum }_{n = 1}^{∞} \frac{{ξ}_{n} {J}_{1} \{ {ξ}_{n} {r}_{f} ( {t}_{0} ) \} {J}_{1} ( {ξ}_{n} a ) {𝒦}_{n} ( {ξ}_{n} r )}{[ {J}_{1}^{2} ( {ξ}_{n} a ) - {J}_{1}^{2} \{ {ξ}_{n} {r}_{f} ( {t}_{0} ) \} ]} \frac{{\overline{ψ}}_{{r}_{f}} ( s )}{s [ s + {αη}_{mi} ( 1 + \frac{{k}_{mi} {η}_{fi}}{{k}_{fi} {η}_{mi}} ) ] + {η}_{fi} {ξ}_{n}^{2} ( s + {αη}_{mi} )} & ( Eq . 34 )\end{matrix}$$

where ψ̅_{rf}(s)=∫₀^{t-t}^{₀}ψ_{rf}(τ)e^{-sτ}dτ, and Kₙ(ξₙr)=Y₀(ξₙr)J₁(ξₙa)−J₀(ξₙr)Y₁(ξₙa). The corresponding eigenvalues are ξ₀=0 and ξₙ. The set of eigenvalues are the positive roots of the transcendental equation J₁(ξₙa)Y₁{ξₙr_{f}(t₀)}−Y₁(ξₙa)J₁{ξₙr_{f}(t_{0)}=}0, n=1, 2, . . . .

The solutions in time domain of the fracture pressure p_{fi} and matrix pressure pₘᵢ; during the fall-off phase are:

$$\begin{matrix}{p}_{fi} = \frac{2}{( {r}_{f}^{2} ( {t}_{0} ) - {a}^{2} ) ( 1 + \frac{{k}_{mi} {η}_{fi}}{{k}_{fi} {η}_{mi}} )} [ \frac{{k}_{mi} {η}_{fi}}{{k}_{fi} {η}_{mi}} ( 1 - {e}^{- {αη}_{mi} ( 1 + \frac{{k}_{mi} {η}_{fi}}{{k}_{fi} {η}_{mi}} ) ( t - {t}_{0} )} ) {\int }_{a}^{{r}_{f} ( {t}_{0} )} {up}_{mi} ( u , {t}_{0} ) d u ++ ( 1 + \frac{{k}_{mi} {η}_{fi}}{k \text{?} {η}_{mi}} {e}^{- {αη}_{mi} ( 1 + \frac{{k}_{mi} {η}_{fi}}{{k}_{fi} {η}_{mi}} ) ( t - {t}_{0} )} ) {\int }_{\text{?}}^{{r}_{f} ( {t}_{0} )} {up}_{fi} ( u , {t}_{0} ) d u -- \frac{{r}_{f} ( {t}_{0} )}{{φ}_{f} {c}_{f}} {\int }_{0}^{t - {t}_{0}} {ψ}_{{r}_{f}} ( t - {t}_{0} - τ ) ( 1 + \frac{{k}_{mi} {η}_{fi}}{{k}_{fi} {η}_{mi}} {e}^{- {αη}_{mi} ( 1 + \frac{{k}_{mi} {η}_{fi}}{{k}_{fi} {η}_{mi}} ) τ} ) d τ ] ++ \frac{{π}^{2}}{2} α \frac{{k}_{mi}}{{k}_{fi}} {η}_{fi} {\sum }_{n = 1}^{∞} [ \frac{{ξ}_{n}^{2} {J}_{1}^{2} \{ {ξ}_{n} {r}_{f} ( {t}_{0} ) \} {𝒦}_{n} ( {ξ}_{n} r )}{[ {J}_{1}^{2} ( {ξ}_{n} a ) - {J}_{1}^{2} \{ {ξ}_{n} {r}_{f} ( {t}_{0} ) \} ]} {\int }_{α}^{{r}_{f} ( {t}_{0} )} {p}_{mi} ( u , {t}_{0} ) u {𝒦}_{0} ( {ξ}_{n} u ) d u \times \times ( \frac{{e}^{- \frac{1}{2} ( {αη}_{mi} ( 1 + \frac{{k}_{mi} {η}_{fi}}{{k}_{fi} {η}_{mi}} ) + \sqrt{σ} ) ( t - {t}_{0} )}}{{η}_{fi} {ξ}_{n}^{2} - \sqrt{σ}} + \frac{{e}^{\frac{1}{2} ( - {αη}_{mi} ( 1 + \frac{{k}_{mi} {η}_{fi}}{{k}_{fi} {η}_{mi}} ) + \sqrt{σ} ) ( t - {t}_{0} )}}{{η}_{fi} {ξ}_{n}^{2} + \sqrt{σ}} ) ] ++ \frac{{π}^{2}}{4} {\sum }_{n = 1}^{∞} [ \frac{{ξ}_{n}^{2} {J}_{1}^{2} \{ {ξ}_{n} {r}_{f} ( {t}_{0} ) \} {𝒦}_{n} ( {ξ}_{n} r )}{[ {J}_{1}^{2} ( {ξ}_{n} a ) - {J}_{1}^{2} \{ {ξ}_{n} {r}_{f} ( {t}_{0} ) \} ]} {\int }_{α}^{{r}_{f} ( {t}_{0} )} {p}_{fi} ( u , {t}_{0} ) u {𝒦}_{0} ( {ξ}_{n} u ) d u \times \times ( \frac{( {αη}_{mi} ( 1 - \frac{{k}_{mi} {η}_{fi}}{{k}_{fi} {η}_{mi}} ) - \sqrt{σ} ) {e}^{- \frac{1}{2} ( {αη}_{mi} ( 1 + \frac{{k}_{mi} {η}_{fi}}{{k}_{fi} {η}_{mi}} ) + \sqrt{σ} ) ( t - {t}_{0} )}}{{η}_{fi} {ξ}_{n}^{2} - \sqrt{σ}} + \frac{( {αη}_{mi} ( 1 - \frac{{k}_{mi} {η}_{fi}}{{k}_{fi} {η}_{mi}} ) + \sqrt{σ} ) {e}^{\frac{1}{2} ( - {αη}_{mi} ( 1 + \frac{{k}_{mi} {η}_{fi}}{{k}_{fi} {η}_{mi}} ) + \sqrt{σ} ) ( t - {t}_{0} )}}{{η}_{fi} {ξ}_{n}^{2} + \sqrt{σ}} ) ] -- \frac{π}{2 {φ}_{f} {c}_{f}} {\sum }_{n = 1}^{∞} [ \frac{{ξ}_{n} {J}_{1} \{ {ξ}_{n} {r}_{f} ( {t}_{0} ) \} {J}_{1} ( {ξ}_{n} a ) {𝒦}_{n} ( {ξ}_{n} r )}{[ {J}_{1}^{2} ( {ξ}_{n} a ) - {J}_{1}^{2} \{ {ξ}_{n} {r}_{f} ( {t}_{0} ) \} ]} {\int }_{0}^{t - {t}_{0}} ( \frac{( {αη}_{mi} ( 1 - \frac{{k}_{mi} {η}_{fi}}{{k}_{fi} {η}_{mi}} ) - \sqrt{σ} ) {e}^{- \frac{1}{2} ( {αη}_{mi} ( 1 + \frac{{k}_{mi} {η}_{fi}}{{k}_{fi} {η}_{mi}} ) + \sqrt{σ} ) τ}}{{η}_{fi} {ξ}_{n}^{2} - \sqrt{σ}} ++ \frac{( {αη}_{mi} ( 1 - \frac{{k}_{mi} {η}_{fi}}{{k}_{fi} {η}_{mi}} ) + \sqrt{σ} ) {e}^{\frac{1}{2} ( - {αη}_{mi} ( 1 + \frac{{k}_{mi} {η}_{fi}}{{k}_{fi} {η}_{mi}} ) + \sqrt{σ} ) τ}}{{η}_{fi} {ξ}_{n}^{2} + \sqrt{σ}} ) {ψ}_{{r}_{f}} ( t - {t}_{0} - τ ) d τ ] , \\ and & ( Eq . 35 ) \\ {p}_{mi} = {p}_{mi} ( r , {t}_{0} ) {e}^{- {αη}_{mi} ( t - {t}_{0} ) +} + \frac{2}{( {r}_{f}^{2} ( {t}_{0} ) - {a}^{2} ) ( 1 + \frac{{k}_{mi} {η}_{fi}}{{k}_{fi} {η}_{mi}} )} [ \frac{{k}_{mi} {η}_{fi}}{{k}_{fi} {η}_{mi}} - ( 1 + \frac{{k}_{mi} {η}_{fi}}{{k}_{fi} {η}_{mi}} ) {e}^{- {αη}_{mi} ( t - {t}_{0} )} + {e}^{- {αη}_{mi} ( 1 + \frac{{k}_{mi} {η}_{fi}}{{k}_{fi} {η}_{mi}} ) ( t - {t}_{0} )} ) \times \times {\int }_{a}^{{r}_{f} ( {t}_{0} )} {up}_{mi} ( u , {t}_{0} ) d u + ( 1 - {e}^{- {αη}_{mi} ( 1 + \frac{{k}_{mi} {η}_{fi}}{{k}_{fi} {η}_{mi}} ) ( t - {t}_{0} )} ) {\int }_{\text{?}}^{{r}_{f} ( {t}_{0} )} {up}_{fi} ( u , {t}_{0} ) d u -- \frac{{r}_{f} ( {t}_{0} )}{{φ}_{f} {c}_{f}} {\int }_{0}^{t - {t}_{0}} {ψ}_{{r}_{f}} ( t - {t}_{0} - τ ) ( 1 - {e}^{- {αη}_{mi} ( 1 + \frac{{k}_{mi} {η}_{fi}}{{k}_{fi} {η}_{mi}} ) τ} ) d τ ] ++ \frac{{π}^{2}}{2} {α}^{2} \frac{{k}_{mi}}{{k}_{fi}} {η}_{fi} {η}_{mi} {\sum }_{n = 1}^{∞} [ \frac{{ξ}_{n}^{2} {J}_{1}^{2} \{ {ξ}_{n} {r}_{f} ( {t}_{0} ) \} {𝒦}_{n} ( {ξ}_{n} r )}{[ {J}_{1}^{2} ( {ξ}_{n} a ) - {J}_{1}^{2} \{ {ξ}_{n} {r}_{f} ( {t}_{0} ) \} ]} {\int }_{α}^{{r}_{f} ( {t}_{0} )} {p}_{mi} ( u , {t}_{0} ) u {𝒦}_{0} ( {ξ}_{n} u ) d u \times \times ( \frac{2 {e}^{- \frac{1}{2} ( {αη}_{mi} ( 1 + \frac{{k}_{mi} {η}_{fi}}{{k}_{fi} {η}_{mi}} ) + \sqrt{σ} ) ( t - {t}_{0} )}}{( {αη}_{mi} ( 1 - \frac{{k}_{mi} {η}_{fi}}{{k}_{fi} {η}_{mi}} ) - \sqrt{σ} ) ( {η}_{fi} {ξ}_{n}^{2} - \sqrt{σ} )} + \frac{2 {e}^{- \frac{1}{2} ( {αη}_{mi} ( 1 + \frac{{k}_{mi} {η}_{fi}}{{k}_{fi} {η}_{mi}} ) + \sqrt{σ} ) ( t - {t}_{0} )}}{( {αη}_{mi} ( 1 - \frac{{k}_{mi} {η}_{fi}}{{k}_{fi} {η}_{mi}} ) + \sqrt{σ} ) ( {η}_{fi} {ξ}_{n}^{2} + \sqrt{σ} )} + \frac{{e}^{- {αη}_{mi} ( t - {t}_{0} )}}{{αη}_{mi} ( {αη}_{mi} ( 2 + \frac{{k}_{mi} {η}_{fi}}{{k}_{fi} {η}_{mi}} ) + 2 {η}_{fi} {ξ}_{n}^{2} )} ) ] + \frac{{π}^{2}}{2} {αη}_{mi} {\sum }_{n = 1}^{∞} [ \frac{{ξ}_{n}^{2} {J}_{1}^{2} \{ {ξ}_{n} {r}_{f} ( {t}_{0} ) \} {𝒦}_{n} ( {ξ}_{n} r )}{[ {J}_{1}^{2} ( {ξ}_{n} a ) - {J}_{1}^{2} \{ {ξ}_{n} {r}_{f} ( {t}_{0} ) \} ]} {\int }_{α}^{{r}_{f} ( {t}_{0} )} {p}_{fi} ( u , {t}_{0} ) u {𝒦}_{0} ( {ξ}_{n} u ) d u \times \times ( \frac{{e}^{- \frac{1}{2} ( {αη}_{mi} ( 1 + \frac{{k}_{mi} {η}_{fi}}{{k}_{fi} {η}_{mi}} ) + \sqrt{σ} ) ( t - {t}_{0} )}}{{η}_{fi} {ξ}_{n}^{2} - \sqrt{σ}} + \frac{{e}^{\frac{1}{2} ( - {αη}_{mi} ( 1 + \frac{{k}_{mi} {η}_{fi}}{{k}_{fi} {η}_{mi}} ) + \sqrt{σ} ) ( t - {t}_{0} )}}{{η}_{fi} {ξ}_{n}^{2} + \sqrt{σ}} ) ] -- \frac{{παη}_{mi}}{{φ}_{f} {c}_{f}} {\sum }_{n = 1}^{∞} [ \frac{{ξ}_{n} {J}_{1} \{ {ξ}_{n} {r}_{f} ( {t}_{0} ) \} {J}_{1} ( {ξ}_{n} a ) {𝒦}_{n} ( {ξ}_{n} r )}{[ {J}_{1}^{2} ( {ξ}_{n} a ) - {J}_{1}^{2} \{ {ξ}_{n} {r}_{f} ( {t}_{0} ) \} ]} {\int }_{0}^{t - {t}_{0}} {ψ}_{{r}_{f}} ( t - {t}_{0} - τ ) ( \frac{{e}^{- \frac{1}{2} ( {αη}_{mi} ( 1 + \frac{{k}_{mi} {η}_{fi}}{{k}_{fi} {η}_{mi}} ) + \sqrt{σ} ) τ}}{{η}_{fi} {ξ}_{n}^{2} - \sqrt{σ}} ++ \frac{{e}^{- \frac{1}{2} ( {αη}_{mi} ( 1 + \frac{{k}_{mi} {η}_{fi}}{{k}_{fi} {η}_{mi}} ) + \sqrt{σ} ) τ}}{{η}_{fi} {ξ}_{n}^{2} + \sqrt{σ}} ) d τ ] , \\ with & ( Eq . 36 ) \\ σ = {α}^{2} {{η}_{mi}^{2} ( 1 + \frac{{k}_{mi} {η}_{fi}}{{k}_{fi} {η}_{mi}} )}^{2} + {η}_{fi}^{2} {ξ}_{n}^{4} + 2 {αξ}_{n}^{2} {η}_{mi} {η}_{fi} ( \frac{{k}_{mi} {η}_{fi}}{{k}_{fi} {η}_{mi}} - 1 ) . \\ \text{?} \text{indicates text missing or illegible when filed} & ( Eq . 37 )\end{matrix}$$

For the uninvaded region, the solutions in Laplace domain are:

$$\begin{matrix}{\overline{p}}_{fu} = {\int }_{0}^{∞} \frac{{ϛ𝒢}_{0} ( ϛ r )}{[ {J}_{1}^{2} \{ ϛ {r}_{f} ( {t}_{0} ) \} + {Y}_{1}^{2} \{ ϛ {r}_{f} ( {t}_{0} ) \} ]} \frac{( s + {αη}_{mu} ) {\int }_{{r}_{f} ( {t}_{0} )}^{∞} u {𝒢}_{0} ( ϛ u ) {p}_{fu} ( u , {t}_{0} ) d u}{( s [ s + {αη}_{mu} ( 1 + \frac{{k}_{mu} {η}_{fu}}{{k}_{fu} {η}_{mu}} ) ] + {η}_{fu} {ϛ}^{2} ( s + {αη}_{mu} ) )} d ϛ ++ α \frac{{k}_{mu}}{{k}_{fu}} {η}_{fu} {\int }_{0}^{∞} \frac{{ϛ𝒢}_{0} ( ϛ r )}{[ {J}_{1}^{2} \{ ϛ {r}_{f} ( {t}_{0} ) \} + {Y}_{1}^{2} \{ ϛ {r}_{f} ( {t}_{0} ) \} ]} \frac{{\int }_{{r}_{f} ( {t}_{0} )}^{∞} u {𝒢}_{0} ( ϛ u ) {p}_{fu} ( u , {t}_{0} ) d u}{( s [ s + {αη}_{mu} ( 1 + \frac{{k}_{mu} {η}_{fu}}{{k}_{fu} {η}_{mu}} ) ] + {η}_{fu} {ϛ}^{2} ( s + {αη}_{mu} ) )} d ϛ ++ \frac{2 {\overline{φ}}_{{r}_{f}} ( s )}{{πφ}_{f} {c}_{f}} {\int }_{0}^{∞} \frac{{𝒢}_{0} ( ϛ r )}{[ {J}_{1}^{2} \{ ϛ {r}_{f} ( {t}_{0} ) \} + {Y}_{1}^{2} \{ ϛ {r}_{f} ( {t}_{0} ) \} ]} \frac{( s + {αη}_{mu} )}{( s [ s + {αη}_{mu} ( 1 + \frac{{k}_{mu} {η}_{fu}}{{k}_{fu} {η}_{mu}} ) ] + {η}_{fu} {ϛ}^{2} ( s + {αη}_{mu} ) )} d ϛ , \\ and & ( Eq . 38 ) \\ {\overline{p}}_{mu} = \frac{{p}_{mu} ( r , {t}_{0} )}{s + {αη}_{mu}} + {αη}_{mu} {\int }_{0}^{∞} \frac{{ϛ𝒢}_{0} ( ϛ r )}{[ {J}_{1}^{2} \{ ϛ {r}_{f} ( {t}_{0} ) \} + {Y}_{1}^{2} \{ ϛ {r}_{f} ( {t}_{0} ) \} ]} \frac{{\int }_{{r}_{f} ( {t}_{0} )}^{∞} u {𝒢}_{0} ( ϛ u ) {p}_{fu} ( u , {t}_{0} ) d u}{( s [ s + {αη}_{mu} ( 1 + \frac{{k}_{mu} {η}_{fu}}{{k}_{fu} {η}_{mu}} ) ] + {η}_{fu} {ϛ}^{2} ( s + {αη}_{mu} ) )} d ϛ ++ {α}^{2} \frac{{k}_{mu}}{{k}_{fu}} {η}_{fu} {η}_{mu} {\int }_{0}^{∞} \frac{{ϛ𝒢}_{0} ( ϛ r )}{[ {J}_{1}^{2} \{ ϛ {r}_{f} ( {t}_{0} ) \} + {Y}_{1}^{2} \{ ϛ {r}_{f} ( {t}_{0} ) \} ]} \frac{( {\int }_{{r}_{f} ( {t}_{0} )}^{∞} u {𝒢}_{0} ( ϛ u ) {p}_{mu} ( u , {t}_{0} ) d u )}{( s + {αη}_{mu} ) ( s [ s + {αη}_{mu} ( 1 + \frac{{k}_{mu} {η}_{fu}}{{k}_{fu} {η}_{mu}} ) ] + {η}_{fu} {ϛ}^{2} ( s + {αη}_{mu} ) )} d ϛ ++ \frac{2 {αη}_{mu} {\overline{φ}}_{{r}_{f}} ( s )}{{πφ}_{f} {c}_{f}} {\int }_{0}^{∞} \frac{{𝒢}_{0} ( ϛ r )}{[ {J}_{1}^{2} \{ ϛ {r}_{f} ( {t}_{0} ) \} + {Y}_{1}^{2} \{ ϛ {r}_{f} ( {t}_{0} ) \} ]} \frac{d ϛ}{( s [ s + {αη}_{mu} ( 1 + \frac{{k}_{mu} {η}_{fu}}{{k}_{fu} {η}_{mu}} ) ] + {η}_{fu} {ϛ}^{2} ( s + {αη}_{mu} ) )} , & ( Eq . 39 )\end{matrix}$$

The solutions in time domain are:

$$\begin{matrix}{p}_{fu} = \frac{1}{2} {\int }_{0}^{∞} \frac{{ϛ𝒢}_{0} ( ϛ r ) {\int }_{{r}_{f} ( {t}_{0} )}^{∞} u {𝒢}_{0} ( ϛ u ) {p}_{fu} ( u , {t}_{0} ) d u}{[ {J}_{1}^{2} \{ ϛ {r}_{f} ( {t}_{0} ) \} + {Y}_{1}^{2} \{ ϛ {r}_{f} ( {t}_{0} ) \} ]} [ \frac{( {αη}_{mu} ( 1 - \frac{{k}_{mu} {η}_{fu}}{{k}_{fu} {η}_{mu}} ) - \sqrt{γ} ) {e}^{- \frac{1}{2} ( {αη}_{mu} ( 1 + \frac{{k}_{mu} {η}_{fu}}{{k}_{fu} {η}_{mu}} ) + \sqrt{γ} ) ( t - {t}_{0} )}}{{η}_{fu} {ϛ}^{2} - \sqrt{γ}} ++ \frac{( {αη}_{mu} ( 1 - \frac{{k}_{mu} {η}_{fu}}{{k}_{fu} {η}_{mu}} ) + \sqrt{γ} ) {e}^{\frac{1}{2} ( - {αη}_{mu} ( 1 + \frac{{k}_{mu} {η}_{fu}}{{k}_{fu} {η}_{mu}} ) + \sqrt{γ} ) ( t - {t}_{0} )}}{{η}_{fu} {ϛ}^{2} + \sqrt{γ}} ] d ϛ ++ α \frac{{k}_{mu}}{{k}_{fu}} {η}_{fo} {\int }_{0}^{∞} \frac{{ϛ𝒢}_{0} ( ϛ r ) {\int }_{{r}_{f} ( {t}_{0} )}^{∞} u {𝒢}_{0} ( ϛ u ) {p}_{mu} ( u , {t}_{0} ) d u}{[ {J}_{1}^{2} \{ ϛ {r}_{f} ( {t}_{0} ) \} + {Y}_{1}^{2} \{ ϛ {r}_{f} ( {t}_{0} ) \} ]} [ \frac{{e}^{- \frac{1}{2} ( {αη}_{mu} ( 1 + \frac{{k}_{mu} {η}_{fu}}{{k}_{fu} {η}_{mu}} ) + \sqrt{γ} ) ( t - {t}_{0} )}}{{η}_{fu} {ϛ}^{2} - \sqrt{γ}} ++ \frac{{e}^{\frac{1}{2} ( - {αη}_{mu} ( 1 + \frac{{k}_{mu} {η}_{fu}}{{k}_{fu} {η}_{mu}} ) + \sqrt{γ} ) ( t - {t}_{0} )}}{\text{?}} ] d ϛ ++ \frac{1}{{πφ}_{f} {c}_{f}} {\int }_{0}^{∞} \frac{{𝒢}_{0} ( ϛ r )}{[ {J}_{1}^{2} \{ ϛ {r}_{f} ( {t}_{0} ) \} + {Y}_{1}^{2} \{ ϛ {r}_{f} ( {t}_{0} ) \} ]} {\int }_{0}^{t - {t}_{0}} \\ [ \frac{( ( {αη}_{mu} ( 1 - \frac{{k}_{mu} {η}_{fu}}{{k}_{fu} {η}_{mu}} ) - \sqrt{γ} ) {e}^{- \frac{1}{2} ( {αη}_{mu} ( 1 + \frac{{k}_{mu} {η}_{fu}}{{k}_{fu} {η}_{mu}} ) + \sqrt{γ} ) τ} )}{( {η}_{fu} {ϛ}^{2} - \sqrt{γ} )} ++ \frac{( ( {αη}_{mu} ( 1 - \frac{{k}_{mu} {η}_{fu}}{{k}_{fu} {η}_{mu}} ) + \sqrt{γ} ) {e}^{\frac{1}{2} ( - {αη}_{mu} ( 1 + \frac{{k}_{mu} {η}_{fu}}{{k}_{fu} {η}_{mu}} ) + \sqrt{γ} ) τ} )}{( {η}_{fu} {ϛ}^{2} + \sqrt{γ} )} ] {ψ}_{{r}_{f}} ( t - {t}_{0} - τ ) d τ d ϛ , \\ and & ( Eq . 40 ) \\ {p}_{mu} = {p}_{mu} ( r , {t}_{0} ) {e}^{- {αη}_{mu} ( t - {t}_{0} )} + {αη}_{mu} {\int }_{0}^{∞} \frac{{ϛ𝒢}_{0} ( ϛ r ) {\int }_{{r}_{f} ( {t}_{0} )}^{∞} u {𝒢}_{0} ( ϛ u ) {p}_{fu} ( u , {t}_{0} ) d u}{[ {J}_{1}^{2} \{ ϛ {r}_{f} ( {t}_{0} ) \} + {Y}_{1}^{2} \{ ϛ {r}_{f} ( {t}_{0} ) \} ]} [ \frac{{e}^{- \frac{1}{2} ( {αη}_{mu} ( 1 + \frac{{k}_{mu} {η}_{fu}}{{k}_{fu} {η}_{mu}} ) + \sqrt{γ} ) ( t - {t}_{0} )}}{{η}_{fu} {ϛ}^{2} - \sqrt{γ}} ++ \frac{{e}^{\frac{1}{2} ( - {αη}_{mu} ( 1 + \frac{{k}_{mu} {η}_{fu}}{{k}_{fu} {η}_{mu}} ) + \sqrt{γ} ) ( t - {t}_{0} )}}{{η}_{fu} {ϛ}^{2} + \sqrt{γ}} ] d ϛ ++ {α}^{2} \frac{{k}_{mu}}{{k}_{fu}} {η}_{fu} {η}_{mu} {\int }_{0}^{∞} \frac{{ϛ𝒢}_{0} ( ϛ r ) {\int }_{{r}_{f} ( {t}_{0} )}^{∞} u {𝒢}_{0} ( ϛ u ) {p}_{mu} ( u , {t}_{0} ) d u}{[ {J}_{1}^{2} \{ ϛ {r}_{f} ( {t}_{0} ) \} + {Y}_{1}^{2} \{ ϛ {r}_{f} ( {t}_{0} ) \} ]} [ \frac{2 {e}^{- \frac{1}{2} ( {αη}_{mu} ( 1 + \frac{{k}_{mu} {η}_{fu}}{{k}_{fu} {η}_{mu}} ) + \sqrt{γ} ) ( t - {t}_{0} )}}{( {αη}_{mu} ( 1 - \frac{{k}_{mu} {η}_{fu}}{{k}_{fu} {η}_{mu}} ) + \sqrt{γ} ) ( {η}_{fu} {ϛ}^{2} - \sqrt{γ} )} ++ \frac{2 {e}^{\frac{1}{2} ( - {αη}_{mu} ( 1 + \frac{{k}_{mu} {η}_{fu}}{{k}_{fu} {η}_{mu}} ) + \sqrt{γ} ) ( t - {t}_{0} )}}{( {αη}_{mu} ( 1 - \frac{{k}_{mu} {η}_{fu}}{{k}_{fu} {η}_{mu}} ) + \sqrt{γ} ) ( {η}_{fu} {ϛ}^{2} + \sqrt{γ} )} + \frac{{e}^{- {αη}_{mu} ( t - {t}_{0} )}}{{αη}_{mu} ( 2 + \frac{{k}_{mu} {η}_{fu}}{{k}_{fu} {η}_{mu}} ) + 2 {η}_{fu} {ϛ}^{2}} ] d ϛ ++ \frac{2 {αη}_{mu}}{{πφ}_{f} {c}_{f}} {\int }_{0}^{∞} \frac{{𝒢}_{0} ( ϛ r )}{[ {J}_{1}^{2} \{ ϛ {r}_{f} ( {t}_{0} ) \} + {Y}_{1}^{2} \{ ϛ {r}_{f} ( {t}_{0} ) \} ]} {\int }_{0}^{t - {t}_{0}} [ \frac{{e}^{- \frac{1}{2} ( {αη}_{mu} ( 1 + \frac{{k}_{mu} {η}_{fu}}{{k}_{fu} {η}_{mu}} ) + \sqrt{γ} ) τ}}{{η}_{fu} {ϛ}^{2} - \sqrt{γ}} ++ \frac{{e}^{\frac{1}{2} ( - {αη}_{mu} ( 1 + \frac{{k}_{mu} {η}_{fu}}{{k}_{fu} {η}_{mu}} ) + \sqrt{γ} ) τ}}{{η}_{fu} {ϛ}^{2} + \sqrt{γ}} ] {ψ}_{{r}_{f}} ( t - {t}_{0} - τ ) d τ d ϛ , \\ with & ( Eq . 41 ) \\ γ = {α}^{2} {{η}_{mu}^{2} ( 1 + \frac{{k}_{mu} {η}_{fu}}{{k}_{fu} {η}_{mu}} )}^{2} + {η}_{fu}^{2} {γ}^{4} + 2 {αγ}^{2} {η}_{mu} {η}_{fu} ( \frac{{k}_{mu} {η}_{fu}}{{k}_{fu} {η}_{mu}} - 1 ) . \\ \text{?} \text{indicates text missing or illegible when filed} & ( Eq . 42 )\end{matrix}$$

At the interface r=r_{f}(t₀), matching the fracture and matrix pressure solutions of the invaded and uninvaded regions, four integral equations with three unknowns are obtained: the fracture pressure p_{f}{r_{f}(t),t}, the matrix pressure pₘ{r_{f}(t),t} and the flux ψr_{f}(t). The p_{f}{r_{f}(t), t}, pₘ{r_{f}(t),t} and ψr_{f}(t) deduced from these equations can then be used in the general solutions to obtain the fracture and matrix pressures as a function of r and t.

The following describes the time-dependent skin computations for longitudinal fracture growth. During fracturing fluid injection, fluid rate and downhole pressure can change significantly with time. To compute the skin evolution of a variable rate well, the flow rate normalization technique can be employed. The time dependent skin is given by

$$s = {( {p}_{D C} )}_{rD = 1} - \frac{{p}_{wD}}{{q}_{wD}} , \qquad ( Eq . 43 )$$

where p_{ωD} is the measured bottom hole dimensionless pressure in the wellbore, and q_{ωD} is the measured dimensionless rate defined respectively by the following equations:

$$\begin{matrix}{p}_{wD} = \frac{{k}_{fi} h ( {p}_{i} - {p}_{wf} )}{141.2 q {μ}_{w} {B}_{w}} , \\ and & ( Eq . 44 ) \\ {q}_{wD} = \frac{{q}_{w}}{q} , & ( Eq . 45 )\end{matrix}$$

In Eq. 39, (P_{DC})_{rD=1} is the dimensionless pressure at the sandface for a constant rate well with no skin defined by

$${( {p}_{DC} )}_{rD = 1} = \frac{{k}_{fi} h ( {p}_{i} - {p}_{fi} ( a , t ) )}{141.2 q {μ}_{w} {B}_{w}} , \qquad ( Eq . 46 )$$

where p_{fi}(a,t) is the fracture pressure at the wellbore during the buildup period obtained from either Eq. 10 or Eq. 21 by setting r=a.

The accuracy of the method is dependent upon the accuracy of the computation of (p_{DC})r_{D=1}. The new mathematical model is used to compute the pressure and then the pressure is normalized with respect to rate. It is implicit that for the above skin computation, the skin is not incorporated in the model, whereas the measurement is.

As the fracture grows, the skin will continue to decrease until it stabilizes to a point beyond which any further increase in the fracture length has no additional benefit. The proposed general purpose model takes into account this variable skin subject to two reasonable assumptions: a) the tip of the fracture is very near the flood front, and b) the permeability per unit length of the fracture is constant. The skin due to the fracture is computed using the well known Hawkins formula, which is

$$s = ( \frac{k}{{k}_{s}} - 1 ) ln \frac{{r}_{s}}{{r}_{ω}} . \qquad ( Eq . 47 )$$

If radius of the modified zone, rₛ, is fixed, then the skin, s, is constant. In this case rₛ moves with the flood front, k=kₘ^{a}, and kₛ=k_{fi}^{a}. Since k<kₛ, the skin is negative. Also since rₛ is inside the logarithmic function, its influence in changing the value of the skin progressively reduces.

In the model according to some embodiments, the variable skin is modeled by using a different absolute permeability in the invaded zone compared to the reservoir. Non-linear regression considering the injection and subsequent fall off data will yield, in addition to other reservoir parameters, invaded and uninvaded zone permeability values which can be substituted in the above equation to determine the skin.

Instructions of software described above (including the analysis software 316 of FIG. 3) are loaded for execution on a processor (such as processor 318 in FIG. 3). The processor includes microprocessors, microcontrollers, processor modules or subsystems (including one or more microprocessors or microcontrollers), or other control or computing devices. A “processor” can refer to a single component or to plural components (e.g., one or multiple CPUs in one or multiple computers).

Data and instructions (of the software) are stored in respective storage devices, which are implemented as one or more computer-readable or computer-usable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

While the invention has been disclosed with respect to a limited number of embodiments, those skilled in the art, having the benefit of this disclosure, will appreciate numerous modifications and variations therefrom. It is intended that the appended claims cover such modifications and variations as fall within the true spirit and scope of the invention.

What is claimed is:

1. A method comprising:
receiving, during a hydraulic fracturing operation in a subterranean structure, pressure data and fluid injection rate data; and
determining, by a processor, one or more properties of the subterranean structure in real-time using the received pressure data and fluid injection rate data.

2. The method of claim 1, further comprising performing an action with respect to the subterranean structure in real-time in response to the determined one or more properties of the subterranean structure.

3. The method of claim 2, wherein performing the action comprises stopping the hydraulic fracturing operation.

4. The method of claim 2, wherein performing the action is in response to a rate of skin decrease being below a threshold, wherein the determined one or more properties include the rate of skin decrease.

5. The method of claim 2, wherein the hydraulic fracturing operation includes a pressure build-up phase and a pressure fall-off phase, and wherein performing the action is during the pressure build-up phase.

6. The method of claim 5, wherein performing the action comprises stopping the hydraulic fracturing operation, and wherein the pressure fall-off phase starts after stopping the hydraulic fracturing operation.

7. The method of claim 6, further comprising:
collecting measurement data during the pressure fall-off phase; and
storing the measurement data collected during the pressure fall-off phase and also measurement data collected during the pressure build-up phase.

8. The method of claim 7, further comprising using the measurement data collected during the pressure build-up phase and the pressure fall-off phase to compute pressure data associated with the subterranean structure.

9. The method of claim 6, further comprising updating a model after the pressure fall-off phase to reflect improved permeability due to the hydraulic fracturing operation.

10. The method of claim 9, wherein updating the model comprises updating a reservoir model.

11. The method of claim 1, wherein the subterranean structure comprises a reservoir, the method further comprising updating one or more of a storativity associated with the reservoir, a shape factor associated with the reservoir, and a transmissivity associated with the reservoir, using measured micro-seismic information.

12. An article comprising at least computer-readable storage medium containing instructions that upon execution cause a computer to:
receive measured pressure data and micro-seismic data caused by a hydraulic fracturing operation; and
use the measured pressure data and the micro-seismic data to characterize a reservoir model.

13. The article of claim 12, wherein characterizing the reservoir model comprises updating parameters of the reservoir model, the parameters including a storativity associated with the reservoir, a shape factor associated with the reservoir, and a transmissivity associated with the reservoir, using measured micro-seismic information.

14. The article of claim 12, wherein the instructions upon execution cause the computer to further:
predict performance of the reservoir using the updated reservoir model.

15. A computer comprising:
a storage media; and
a processor to:
receive, during a hydraulic fracturing operation in a subterranean structure, pressure data and fluid injection rate data; and
determine, by a processor, one or more properties of the subterranean structure in real-time using the received pressure data and fluid injection rate data

16. The computer of claim 15, wherein the determined one or more properties causes a decision to stop the hydraulic fracturing operation.

17. The computer of claim 16, wherein the determined one or more properties comprise a rate of skin decrease, wherein the rate of skin decrease being below a threshold causes the decision to stop the hydraulic fracturing operation.
